(19) United States
(12) Patent Application Publication
(10) Pub. No.: US 2001/0037328 A1
(43) Pub. Date: Nov. 1, 2001

(54) Method and system for interfacing to a knowledge acquisition system

(76) Inventors: James D. Pustejovsky, Arlington, MA (US); Robert J.P. Ingria, Somerville, MA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/742,459

(22) Filed: Dec. 19, 2000

Related U.S. Application Data
(60) Provisional application No. 60/191,883, filed on Mar. 23, 2000.
(60) Provisional application No. 60/228,616, filed on Aug. 28, 2000.

(51) Int. Cl. G06F 17/30; G06F 17/27; G09G 5/00

(52) U.S. Cl. 707/3; 707/4; 707/5; 704/9; 345/781

(57) ABSTRACT

A query is received via a computer user interface. The query is processed to identify the semantic content contained in the query. An information store is accessed to obtain related categories of information based on the semantic content of the query. The information is presented over the computer user interface, thereby providing the user with context relevant information. The invention increases navigability of a large information store by eliminating the indiscriminate display of all information relating to the keywords identified in the query.

### BACKGROUND OF THE INVENTION

This invention generally relates to the field of information management. More particularly, the present invention provides techniques which allows a user to pose query to and receive an answer from a natural language system.

The expansion of the Internet has proliferated “on-line” textual information. Such on-line textual information includes newspapers, magazines, WebPages, email, advertisements, commercial publications, and the like in electronic form. By way of the Internet, millions if not billions of pieces of information can be accessed using simple “browser” programs. Information retrieval (herein “IR”) engines such as those made by companies such as Yahoo! allow a user to access such information using an indexing technique. The indexing technique includes full-text indexing, in which content words in a document are used as keywords. Full text searching had been one of the most promising of recent IR approaches. Unfortunately, full text searching has many limitations. For example, full text searching lacks precision and often retrieves literally thousands of “hits” or related documents, which then require further refinement and filtering. Additionally, full text searching has limited recall characteristics. Accordingly, full text searching has much room for improvement.

Techniques such as the use of “domain knowledge” can enhance an effectiveness of a full-text searching system. Domain knowledge techniques often provide related terms that can be used to refine the full-text searching process. That is, domain knowledge often can broaden, narrow, or refocus a query at retrieval time. Likewise, domain knowledge may be applied at indexing time to do word sense disambiguation or simple content analysis. Unfortunately, for many domains, such knowledge, even in the form of a thesaurus, is either generally not available, or is often incomplete with respect to the vocabulary of the texts indexed.

There have been attempts to use natural language understanding in some applications. As merely an example, U.S. Pat. No. 5,794,050 in the names of Dahlgren et al. (herein Dahlgren) utilized a conventional rule based system for providing searches on text information. Dahlgren, et al. use a naive semantic lexicon to “reason” about word senses. This simple semantic lexicon brings some “common sense” world knowledge to many stages of the natural language understanding process. Unfortunately, the design of such a semantic lexicon follows fairly standard taxonomic knowledge representation techniques, and hence the reasoning process making use of this taxonomy is generally incomplete. That is, it may provide a first level method for performing a relatively simple search, but often lacks a general ability to conduct a detailed retrieval to provide a comprehensive answer to a query. Fundamentally, the method and system described in Dahlgren, employs a natural language understanding system to provide a “concept annotation” of text for subsequent retrieval. Furthermore, when the system is used to query a database, it matches on pointers to the text provided by the annotation rather than an answer to the query.

Although some of the above techniques are fairly sophisticated compared to the information retrieval search engines so ubiquitous on the internet (e.g., Inktomi or Alta Vista), the results of the queries are “hits” rather than “answers”; that is, a hit is the entire text that matches the indexing criteria, while an answer on the other hand is the actual utterance (or portion of the text) that satisfied a user query. For example, if the query were “Who are the officers of Microsoft, Inc?”, a hit-based system would return all the documents that contain this information anywhere within them, whereas an answer-based system would return the actual value of the answer, namely the officers.

From the above, it is seen that a technique for improved information retrieval is highly desirable.

### SUMMARY OF THE INVENTION

According to the invention, a method for dynamic categories in an information retrieval system is provided including: receiving a query from a user; searching for information in response to said query; and displaying to the user relevant documents categorized into a plurality of classifications or subclassifications based on content of the query.

One embodiment of the present invention provides a dynamic category method in an information retrieval system, having: a query received from a user; searching for information in response to the query; and displaying to the user relevant documents categorized into at least one classification based on content of the query.

In another embodiment of the present invention, a system for providing related categories in response to a user query is disclosed. The system includes: a first display window for receiving a query from a user; an engine coupled to said first display window for searching for an answer, including, one or more related categories, in response to said query; and a portion in the first display window for displaying to said user said answer.

In yet another embodiment of the present invention, a conversational search method is provided, having: a query received from a user; a display showing a plurality of selections to the query, where at least two selections of the plurality of selections have different senses; a selection is received from the user; and the selection is processed in order to display an answer to the query.

These and other embodiments of the present invention are described in more detail in conjunction with the text below and attached figures.

### BRIEF DESCRIPTION OF THE DRAWINGS

The teachings of the present invention can be readily understood by considering the following detailed description in conjunction with the accompanying drawings:

FIG. 1 shows information flow of a search system according to the invention;

FIG. 2 illustrates an embodiment of the search engine used in the present invention;

FIG. 3 is an illustrative example of a computer user interface display for receiving a user query;

FIGS. 4A and 4B show illustrative examples of a computer user interface display for handling queries which have different senses;

FIG. 5 shows another illustrative example of a computer user interface display for receiving a user query;

FIG. 6 illustrates a computer user interface display showing dynamically generated related categories in addition to the direct answers to a query;

FIG. 7 illustrates the display of FIG. 6 which has updated as a consequence of selecting a dynamic category;

FIGS. 8A and 8B illustrate an example of a computer user interface display responding to a query having more than one sense;

FIG. 9 shows the result of selecting one of the categories shown in FIG. 8B; and

FIG. 10 shows an illustrative example of a syntactic-semantic composition.

### DESCRIPTION OF THE SPECIFIC EMBODIMENTS

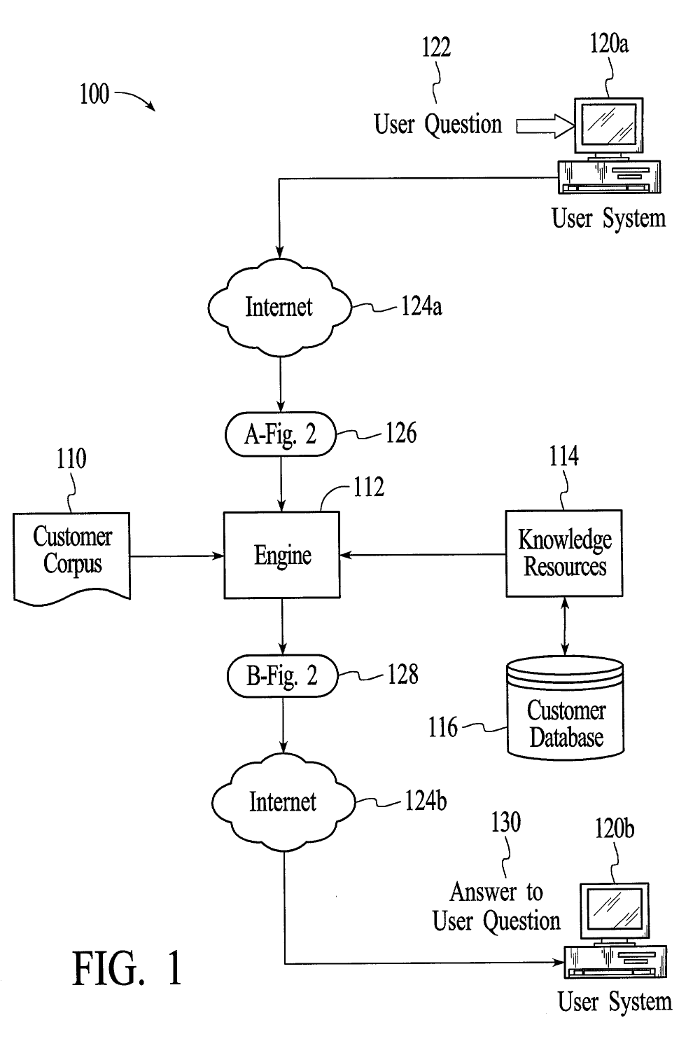

FIG. 1 shows a simplified overview of an illustrative example of a natural language system according to the present invention. A customer provides a corpus 110 of information. A corpus can be any arrangement of persistent information. For example a typical corpus may comprise a database of text, organized into a large number of documents. The customer corpus 110 is input into the natural language engine 112. The natural language engine creates a customer database 116 using a knowledge resources component 114 of the engine. Once the customer database 116 has been created, the engine 112 is ready to receive and answer questions from users who want to access the customer's information.

A user at a user system 120 enters a user query 122 which is communicated though a communication network, for example, the Internet 124a, to engine 112. To simplify the discussion, the two-way flow of information between the user and the natural language engine 112, information flow is linearized by splitting the communication network 124 and user system 120. The split components are identified by “a” and “b” references; thus the user system is shown as two components, as is the Internet 124. Engine 112 receives the user query 122 and using knowledge resources 114 and customer database 116 returns through the though a communication network, for example, Internet 124b an answer to the user query 130 to user system 120b.

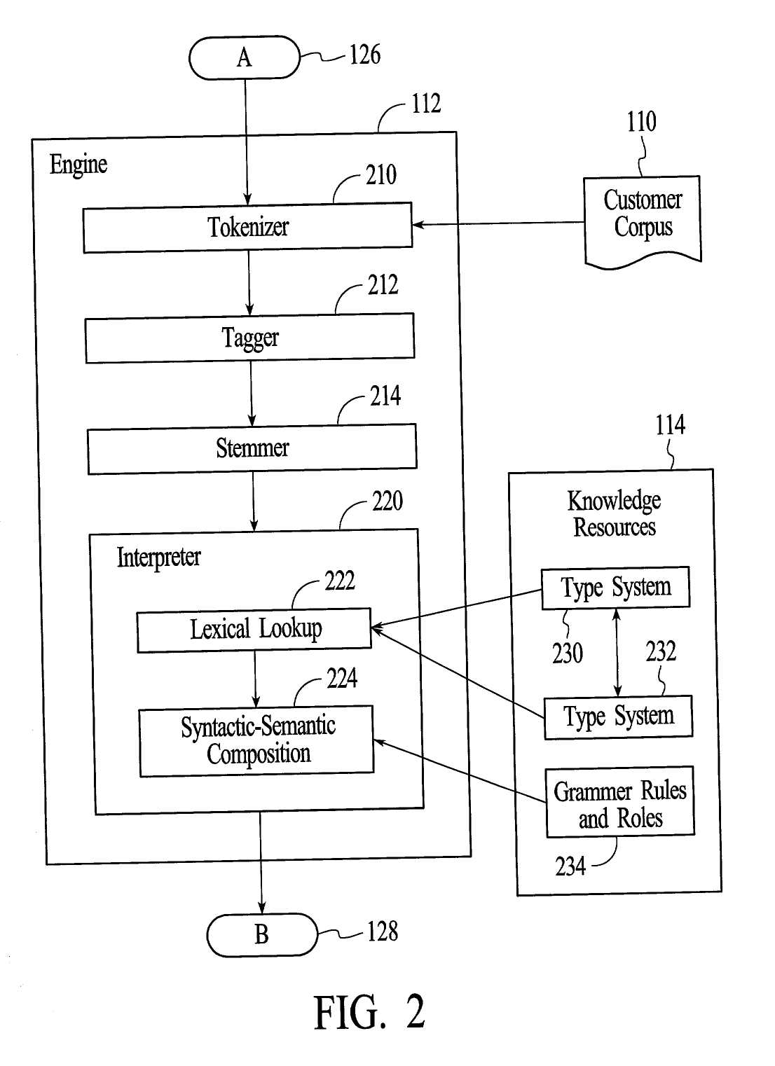

FIG. 2 illustrates an expanded view of the engine 112 and the knowledge resources component 114 of an embodiment of the present invention. In one embodiment the engine 112 is the processor of text and can recognize old and understand new concepts and phrases in questions and then construct customized answers. The engine includes a tokenizer 210, a tagger 212, a stemmer 214, and an interpreter 220. The engine 112 through its interpreter 220 receives information from the knowledge resources 114. The interpreter includes a lexical look-up 222 and a syntactic-semantic composition 224. The knowledge resources include a lexicon 230 interacting with a type system 232, and grammar rules and roles 234.

The tokenizer 210 takes a text stream composed of punctuation, words, and numbers from a user query coming from 126 or a customer corpus 110 and creates tokenized elements. The tokenizer performs this procedure by first dividing the text into subparts of orthographic words which are unbroken sequences of alphanumeric characters delimited by white space; next, grouping the orthographic words into sentences; and then separating punctuation from words, except where the punctuation should remain part of the word like in abbreviations.

The tagger 212 then attaches to each tokenized element a grammatical category or part of speech label based on the Brill ruled-based tagging algorithm. The tagger 212 uses a tag dictionary, which has a master list of words with tags. The lexical rules provide a means for the tagger 212 to guess a word and contextual rules provide a means to interpret words and tags according to context.

Next the stemmer 214 provides a system name to be used for retrieval for each labeled/tokenized element. The stemmer 212 creates a root form and assigns a numeric offset designating the position in the original text. The stemmer 214 uses a stem dictionary, which is a master list of stems.

The interpreter 220 translates the part of speech labels of the tagger 212 into fully specified syntactic categories and uses these new categories with the lexical lookup form of the stemmer 214 to see if the stem already exists in the knowledge resources 114. If the stem exists, the syntactic and semantic information in the lexical entry, for example word, is added to the syntactic category. If the stem is unknown, the interpreter adds default information. The lexical lookup form using, for example, the word's stem, is done by the lexical lookup 222 which interacts with a lexicon 230 and a type system 232. The lexicon 230 has syntactic concepts and includes a file for each part of speech. The type system 232 has semantic concepts.

The interpreter 220 also parses (assembles syntactic compositions out of) these categories by applying the grammar rules to combine them into larger syntactic constituents. By applying the grammar rules and the grammar roles 234 and the lexical semantic information from the lexical look-up 222, the interpreter 220 makes a syntactic-semantic composition 224 as it parses. The resulting syntactic-semantic composition 224 (this also called a LexLF in one embodiment) is the meaning of the input text stream. The LexLF is then used in conjunction with the customer database 116 to generate a direct answer and related categories to the user query 122. This answer(s) is output from engine 112 at node B 128, which then sent via Internet 124b back to the user 120b.

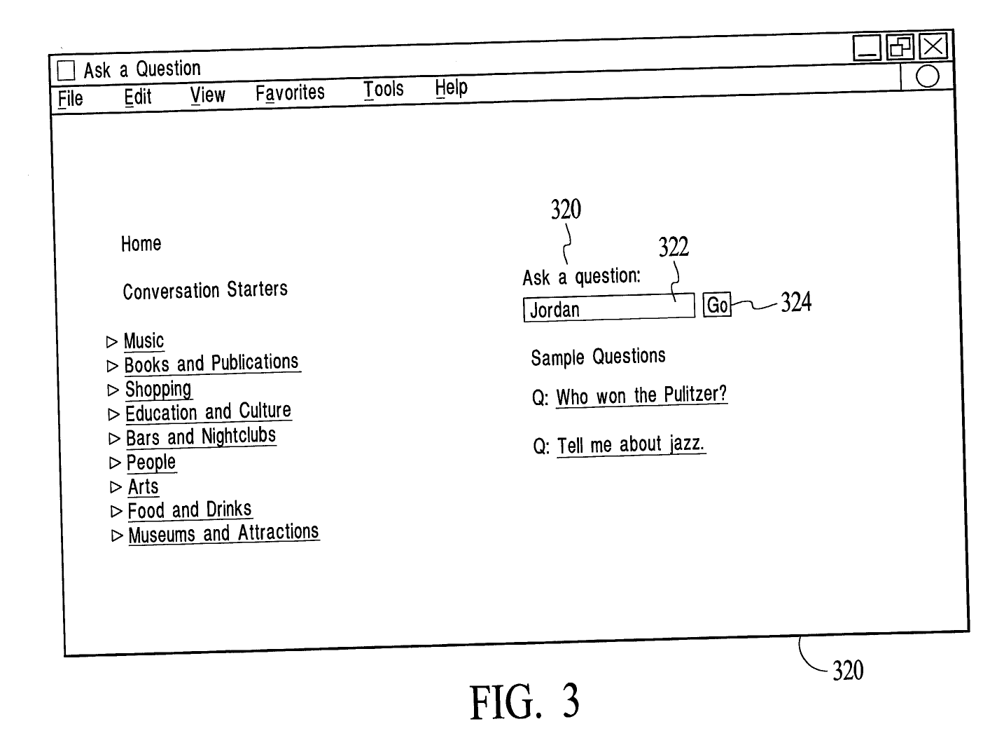

FIG. 3 illustrates a user interface where a user may enter a query in one embodiment of the present invention. FIG. 3 shows a window 310 which contains an input box for “Ask a question:” 320. For example, the query “Jordan” 322 may be asked.

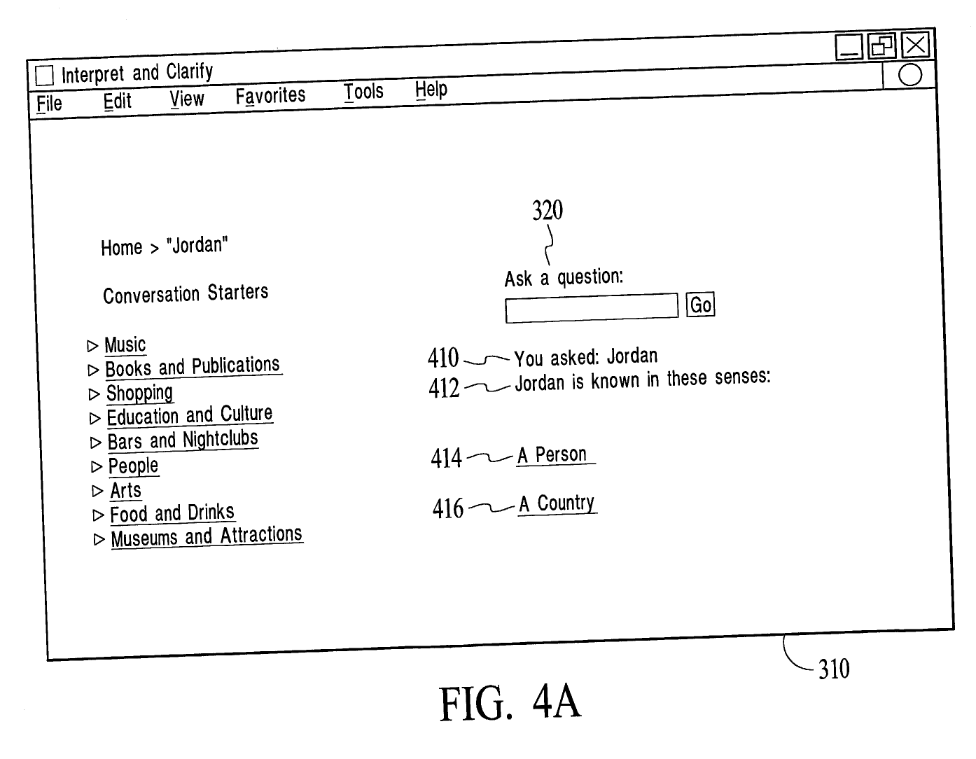

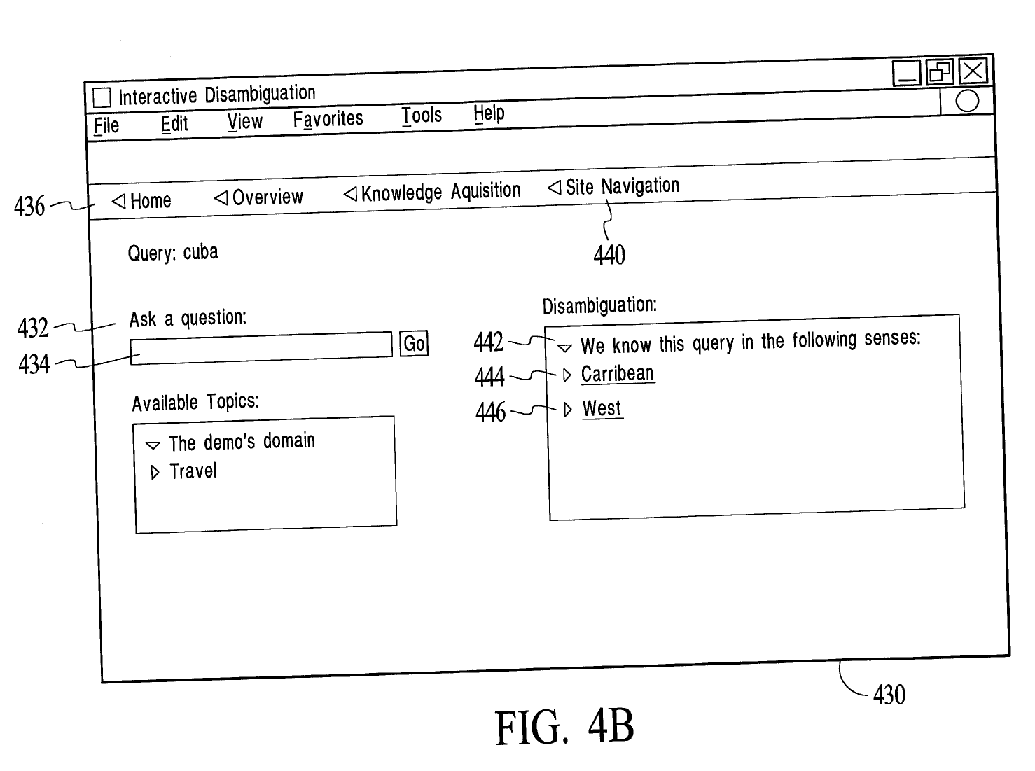

FIG. 4A shows a display giving the engine response to an ambiguous question in one embodiment of the present invention. FIG. 4A displays the question “You asked: Jordan” 410 and next displays the system response, for example, “Jordan is known in these senses” 412: as “A Person” 414 and as “A Country” 416. The user would then select, for example, “A Person” 414 and receive an answer from the computer which interpreted “Jordan” as a person.

An embodiment of the present invention may return relevant documents as answers to a query, possibly ranked according to relevance, but more importantly, categorized dynamically into relevant classifications and subclassifications, as motivated (or directed) by the content of the query. In particular, the relevant related categories are selected dynamically, on-the-fly, depending on the context (semantic and syntactic content) of the user's query. These dynamically produced “related categories” allow for a more natural and intuitive navigation of the document set than is possible using conventional search technologies. Thus, a query about “fixing a kitchen sink” might include associated context relevant categories such as “books on home repair”, locations of hardware stores carrying plumbing supplies, and so on; while leaving out for example the history of the kitchen sink, or styles of kitchen sinks.

To illustrate the above embodiment, consider a broad concept query such as “antiques”, which in a conventional search system is treated as a keyword search, interpreted as a query vector. In this embodiment, the engine 112 interprets the query, and categorizes, subcategorizes, and qualia-categorizes it. These steps give rise to a natural clustering of the answers to the query, grouped according to the compositional mechanisms of the type system. A general type query such as “antiques,” gives rise to natural subtypes, if they are present and dynamically inferable from the texts, such as “American antiques”, “antique furniture”, “antique glass”, and so forth. Qualia-categorized types, on the other hand, are related categories generated along orthogonal dimensions according to the type system, and the compositions that result from a particular query. These generate categories such as “antique shopping,” “antique shows”, “selling antiques”, and so forth. Together, these two types of related categories add depth and breadth to the navigability of information as it is returned from a query.

FIG. 4B shows another display giving the engine response to another ambiguous question in a second embodiment of the present invention. FIG. 4B has an “Ask a Question” 432 input block 434 , in which the question “Cuba” was previously entered. FIG. 4B displays the question “Query: cuba” 436 and displays the system response, for example, “We know this query in the following senses” 442: as “Caribbean” 444 and as “West” 446. The user would then select, for example, “Caribbean” 444 and receive an answer from the computer based on this interpretation.

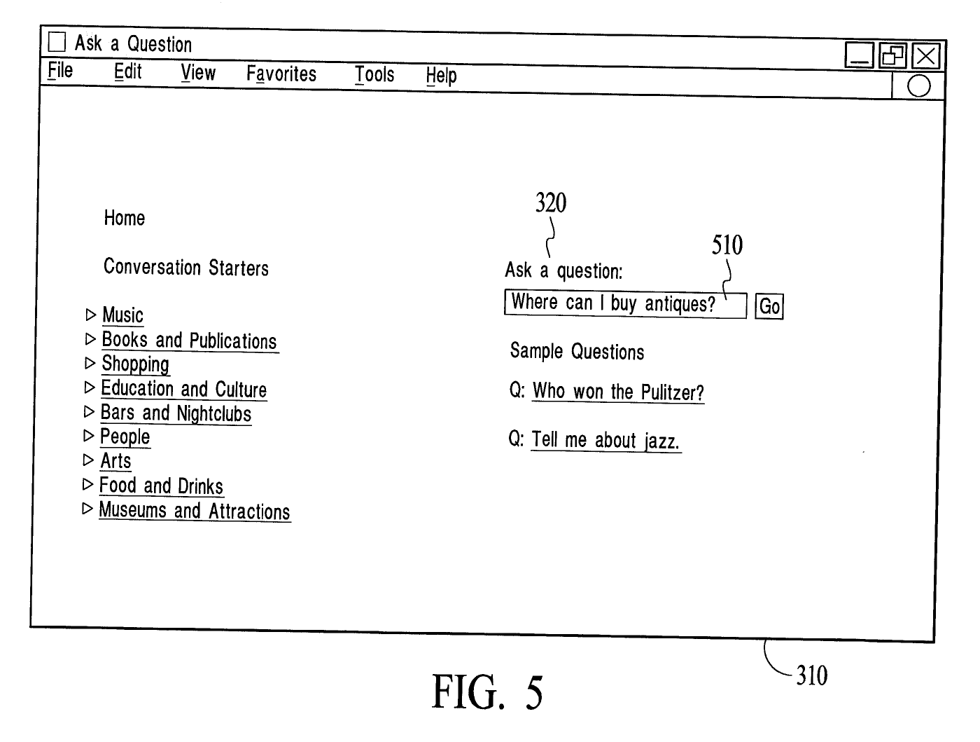

FIG. 5 illustrates an example query for “antiques” in one embodiment of the present invention. In FIG. 5 the question asked is “Where can I buy antiques?” 510 .

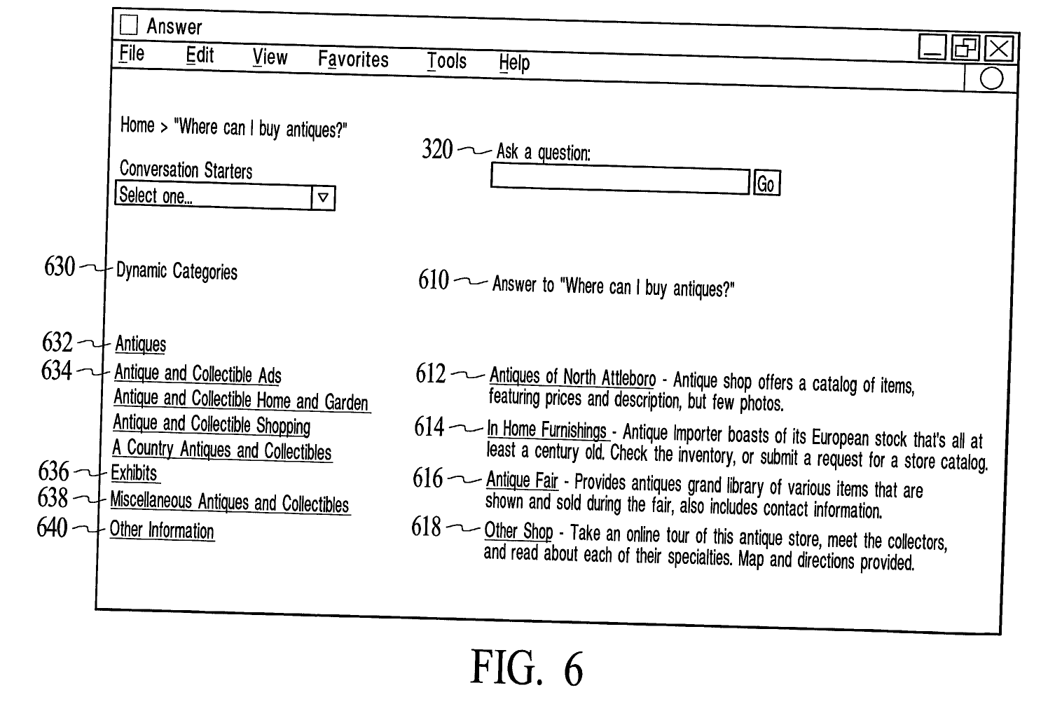

FIG. 6 illustrates the direct answers and dynamic (related) categories that are returned by one embodiment of the present invention. In FIG. 6, there is displayed the question “Where can I buy antiques?” 610 and a listing of four direct answers: “Antiques of North Attleboro” 612, “In Home Furnishings” 614, “Antiques Fair” 616, and “Other Shop” 618. FIG. 6 also shows several dynamic categories 630, including “Antiques” 632, “Antiques and Collectible Ads” 634, “Exhibits” 636, “Miscellaneous Antiques and Collectibles” 638, and “Other Information” 640.

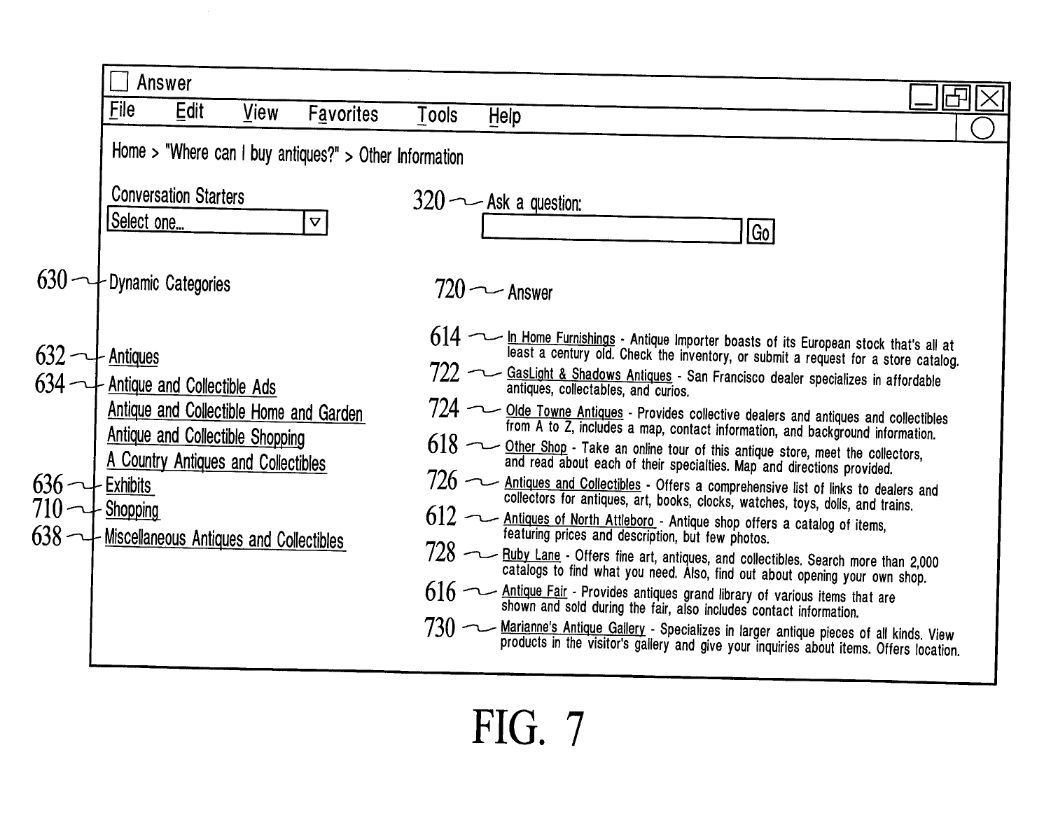

FIG. 7 illustrates the results of selecting one of the dynamic categories shown in FIG. 6. As a result of the selection, in this case the category “Other Information” 640 was selected, the dynamic categories 630 may change. Thus, in this example, the dynamic category “Shopping” 710 has been added to the dynamic categories as a consequence of selecting “Other Information”. The Answer 720 may or may not include one or more of the answers given in FIG. 6, for example, 612,614, 616, 618, and may include additional items such as “Gas and Shadows Antiques” 722, “Old Towne Antiques” 724, and/or “Antiques and Collectibles” 726.

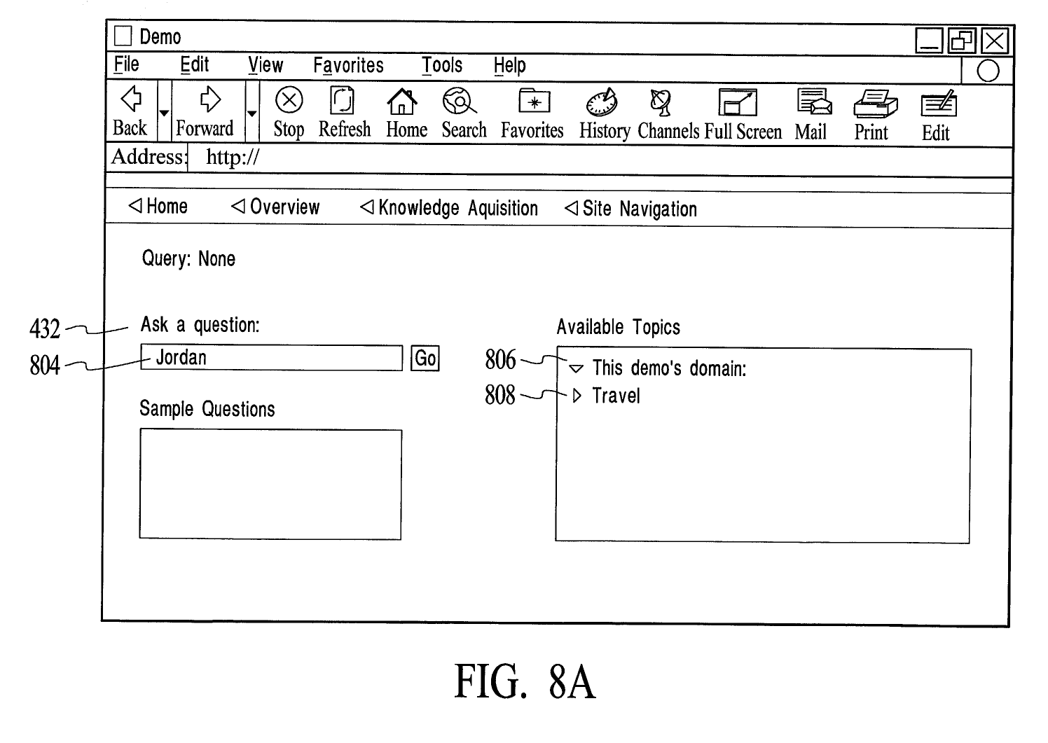

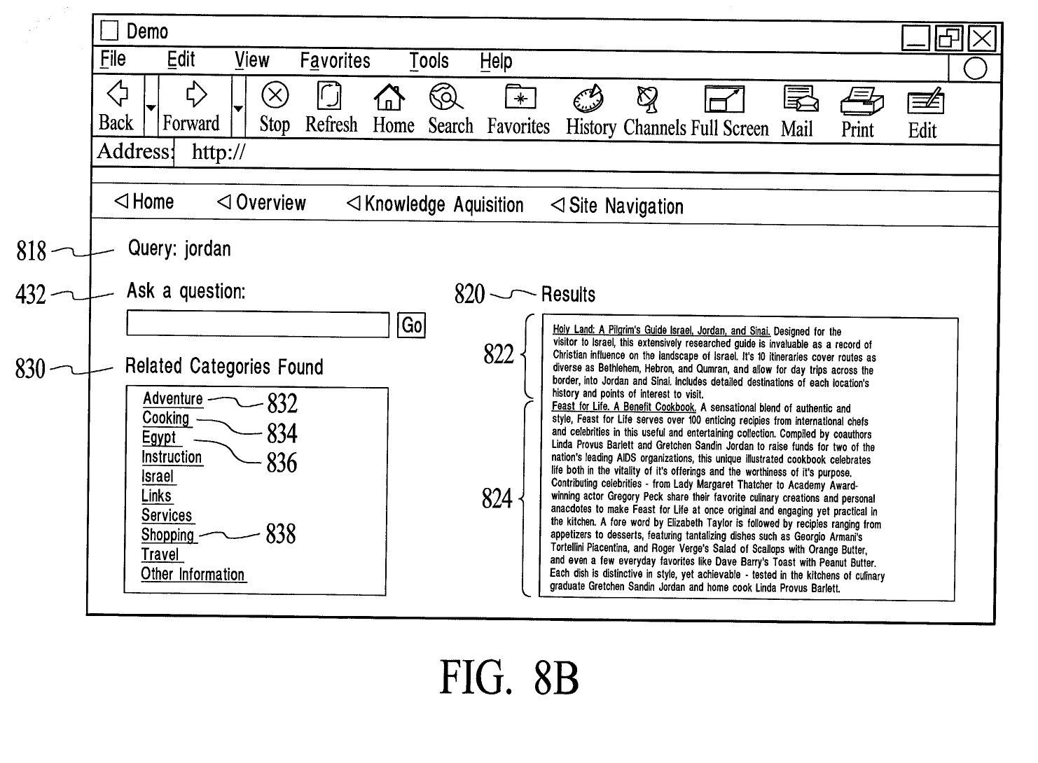

FIG. 8A illustrates an example query for “Jordan” in another embodiment of the present invention. FIG. 8A has an “Ask a Question” input block 432, in which the question “Jordan” 804 is entered. The domain 806 is given as “Travel” 808.

FIG. 8B illustrates the direct answers and dynamic (related) categories that are returned by a second embodiment of the present invention. In FIG. 8B, there is displayed the question “Query: Jordan” 818 and a listing of two direct answers: “Holy Land; A Pilgrim's Guide to Israel, Jordan, and the Sinai” 822, and “Feast for Life: A Benefit Cookbook” 824. Thus unlike FIGS. 3 and 4A, this embodiment uses “Jordan” in the senses of a place and of a person. FIG. 8B also shows several related categories 830, including “Adventure” 832, “Cooking” 834, “Egypt” 836, and “Shopping” 838.

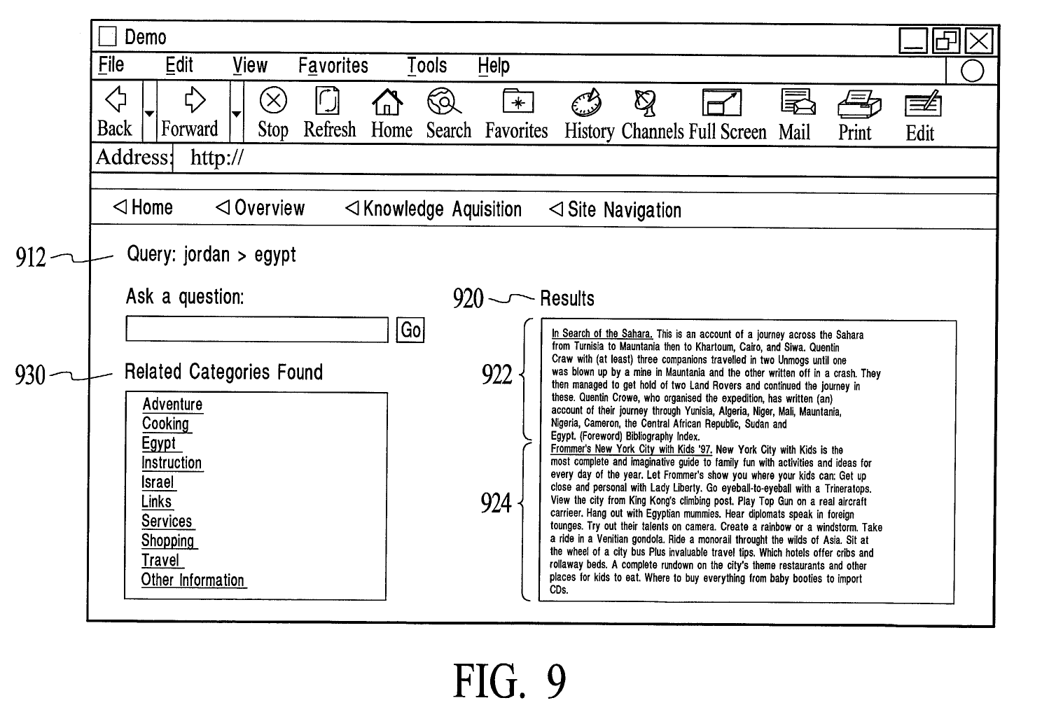

FIG. 9 illustrates the results of selecting one related category of FIG. 8B of a second embodiment of the present invention. FIG. 9 shows the related category “Egypt” 836 previously selected in FIG. 8B. In FIG. 9 the path “Query: Jordan >Egypt” 912 is shown. In FIG. 9, the related categories 930 are the same as the related categories 830 in FIG. 8B, except the related category “Egypt” is absent. The Results 920 may include items such as “In Search of the Sahara” 922, and “Frommer's New York City with Kid's ‘97” 924.

In an embodiment of the present invention, LexLF, represents the semantics or meaning of the query or utterance. Two important subclasses of LexLF are: EntityLexLF, which represent the semantics of objects with GLEntity semantics, i.e., entities or types, for example nouns and FunctionLexLF, which represents the semantics of objects with GLEvent semantics, for example, verbs or adjectives with event readings. As a simple example of the structure of LexLF, consider the semantics for the utterance “Where can I read books about France?”

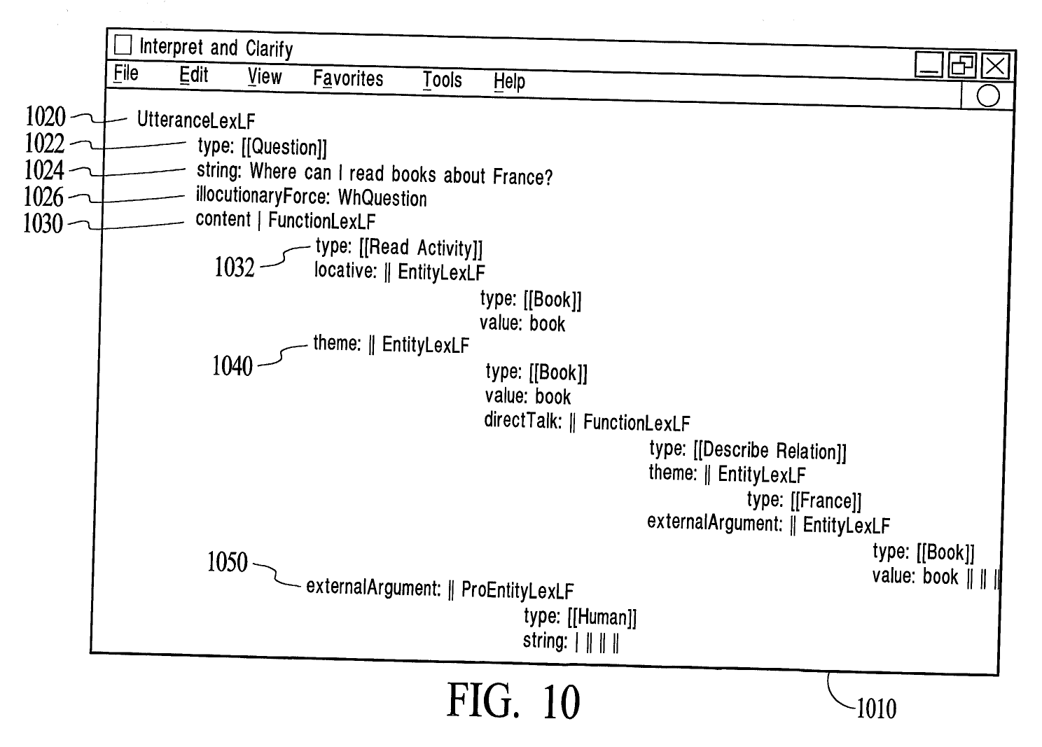

FIG. 10 shows an example of a syntactic-semantic composition as result of parsing an utterance of an embodiment of the present invention. The example utterance is “Where can I read books about France?” 1024 The semantics representing the utterance is UtteranceLexLF 1020. The “content” 1024 has a FunctionLexLF semantic 1030 representing “I read books about France,” and where the type is “Read Activity” 1032. This is a FunctionLexLF query. The description of the terms in FIG. 10, as well as further details on how the LexLF's are constructed is given in U.S. Pat. application No. 09/662,510, which is herein incorporated by reference.

In one embodiment, after the user has input the query in 320 in FIG. 5, the engine 112 analyzes the query and generates an UtteranceLexLF semantic structure as a result of Syntactic-Semantic Composition 224 of FIG. 2. This UtteranceLexLF either represents a EntityLexLF or an EventLexLF. In another embodiment there may be other LexLF's such as ClausalLexLF or ConjunctionLexLF. After the EntityLexLF or EventLexLF is analyzed a direct answer and/or related categories are returned. If there is an EntityLexLF query which is ambiguous, that is there are a plurality of interpretations for the query, the engine will prompt the user for a selection of which interpretation to use, as seen in the example for “Jordan” 322 in FIGS. 3 and 4. Further details for one embodiment of the present invention are given below.

EntityLexLF Queries for one embodiment

In one embodiment, the first decision the system makes is to determine whether the EntityLexLF represents a type query or a specific entity query. This is determined by the value of #typeName, which is set as follows:

At lexical lookup time, for known nouns, #typeName is set to “true,” if the noun is common; or if the noun is proper, but there also exists a common noun, with the same #stem and the same #type. This is done because there are some “pseudo-proper” nouns, which have a proper tag from the tagger but common noun semantics. This can occur in texts that capitalize the first letter of each word of their contents, such as Titles and Headers.

During parsing, #typeName is set to “false” if a premodifier is Proper, and if it is not a location binder. This latter condition is to allow location compounds to be treated as type queries: e.g. “Boston restaurants” wants all the entities of type restaurant in Boston, not entities named “Boston restaurant(s)”.

If the query is a type query, the first thing the system does is to check whether the EntityLexLF has qualia or not.

If the EntityLexLF does not have qualia, the system does the following:

1. It checks to see if there are any documents containing entities with this type.

If there are none, the system returns NO-ANSWER.

2. If there are such documents, these documents are cached in a temporary variable.

3. The system then gets the related categories for the type. Related categories are determined as follows:

a. First, the system gets all entities that have the specified type.

b. Then the system finds the events, if any, that contain an argument bound to one of these entities. If such events exist, they are added to the related categories, bound by the iName(interface Name; a human readable version of an internal type name) of the type of the event.

c. Next the system finds all instances in which one of these entities is modified by qualia. If there are such cases, they are added to the related categories, bound by a composite iName formed in the following manner: the left component is the combining iName of the type of the element that binds the quale (if this type has no meaningful iName, it gets the default iName of “Miscellaneous”); the right element is the iName of the type. For example, if the query was about “clubs?” then qualia such as “jazz” might yield “jazz clubs.”

d. Then the system finds all instances in which one of these entities is a quale modifier to some other entity. If there are such cases, they are added to the related categories, bound by a composite iName formed in the following manner: the left component is the combining iName of the type queried, which in this case binds the quale; the right element is the iName of the type that is modified by qualia (if this type has no meaningful iName, it gets the default iName of “Miscellanea”). For example, there may be two entities: “resorts” and “clubs.” Thus “clubs” in “resorts with clubs” would be a qualia modifier to “resorts.”

e. Finally, the system finds all the subtypes of the type queried. It augments these with any types that have the type queried as the value of their #hasElement quale, since this is analogous to subtyping. It then finds the entities, if any, that has these types, and then adds them to the related categories, bound by the iName of the type.

4. Then the cached documents are filtered so that any documents that also appear in related categories are removed. The links to the documents removed are displayed as related categories.

5. Finally, the remaining links to the cached documents are displayed as direct answers. In another embodiment they are displayed as a related category of “Miscellaneous.”

In this embodiment the direct answers and the related categories represent all the documents the system found containing entities with the specified type. A link to a related category may also represent a more specific query. In an alternative embodiment, this more specific query may be used by the system as an input query to give another more specific direct answer with more specific categories. This procedure may be recursively repeated by the system with or without the user seeing any intermediate results.

If the EntityLexLF has qualia, the system does the following:

1. It checks to see if there are any documents containing entities with this type that are restricted by the type specified by the qualia.

2. If there are such documents, these documents will be displayed as direct answers; if there are none, only related categories will be displayed.

3. The system then gets the related categories for the type. The system computes related categories by finding all articles that contain entities with similarly qualia delimited types where:

a. the type of the head is one or two levels down from the type queried (i.e. where the type is one of the immediate subtypes of the type queried, or a subtype of these immediate subtypes); and

b. the type of the qualia modifier is either the same as the qualia modifier in the initial type query or one type down from this type (i.e. where the modifier is one of the immediate subtypes of the modifier); and

c. only entity qualia are considered. For example, let “private club” be a subtype of “club” and “hot jazz” be a subtype of “jazz.”Then if the direct answer was “jazz club,” the related category for a. is “jazz private club” and for b. is “hot jazz club.” In another embodiment the cross product or “hot jazz private club” is also included.

4. If there are no direct answers and no related categories at this point, the system tries the fallback strategy of looking for the immediate supertype (or immediate supertypes, in the case of complex types) of the type queried, restricted by the same qualia as in the initial query.

5. If there are direct answers and/or related categories, these are displayed. If neither exist, the system gives back NO-ANSWER.

If the query is an entity query, once again the first thing the system does is to check whether the EntityLexLF has qualia or not.

If the EntityLexLF does not have qualia, the system does the following:

1. First, the system checks to see if the entity is known at all. If it is not, it returns NO-ANSWER.

2. Next, the system checks to see if the entity is ambiguous (i.e. is known with more than one type). If it is, the system queries the user for a disambiguation. The choices are displayed to the user and the user selects through a GUI the choice he/she wants. This is, in one embodiment, a conversational feedback mode in which the system employs feedback to the user to narrow its choices rather than assuming a selection. Once the desired type is selected, the procedure continues in the same manner as for an unambiguous entity.

3. Then the system gets related types for the type of the entity, to display as related categories. These related types are calculated in the same manner as in the case of a type query without qualia.

4. Next the system gets all articles with the entity appearing in the specified type and adds them to the direct answers.

5. Then the system gets all articles where the entity appeared as an argument to a relation and adds them to the direct answer.

6. Finally, the system gets all the articles where the entity appeared delimited by qualia and adds them to the direct answer.

7. Then the system displays the direct answers and the related categories.

If the EntityLexLF has qualia, the system does the following:

1. As before, the first thing the system does is to check to see whether the entity is known at all, and returns NO-ANSWER if it is not. One thing that is different is that the system checks for the presence of the #properName quale and uses this as an alternate lookup name if the #value of the EntityLexLF is not found as the alias or name of an entity.

2. Next, as before the system checks to see if the entity is ambiguous or not, and requests a disambiguation from the user if it is. This is, again, displaying the choices to the user and receiving the user's selection.

3. From this point, retrieval proceeds as in the case of entity query without qualia, i.e. related categories are calculated; types, events, and qualia are found and added to the answer.

FunctionLexLF Queries for one embodiment

In an embodiment of the present invention, for event queries, which include the relation(s) between entities, the system performs the following:

1. The first thing the system does is to get the inferred events for the type of the FunctionLexLF. This is lexically specified for individual Event types. For example, [[Buy Product Activity]] has two inferred events: [[Possession State]] (i.e. if something is bought, somebody now owns it) and [[Sell Product Activity]] (i.e. if something is bought, it must have been sold).

2. Next, given the actual and inferred type(s), if any, of the FunctionLexLF, the system checks to see if any of them are known.

3. If none are known, the system returns NO-ANSWER.

4. Then the system checks to see if the FunctionLexLF has any non-pronominal arguments.

5. If it does not, the system selects all documents that contain either the explicitly specified event or one of the inferred events.

6. If it does contain non-pronominal arguments, the system first checks to make sure that at least one of them is known to the system.

7. If none of them are known, the system returns NO-ANSWER.

8. If at least some of the arguments are known, the system finds all instances of entities that are compatible with each argument. These will be identical entities for EntityLexLF arguments that have an entity interpretation, and entities with the identical type for EntityLexLF arguments that have a type interpretation.

9. The system then finds all events and inferred events that have the specified sets of entities in the specified arguments.

10. Next the system gets all lexicalized events that are compatible with the specified events and inferred events. Lexicalized events are events that are contained within the meaning of lexical items, typically a noun. For example, if we ask “Who plays guitar?”, we want guitarists to come back, since it is part of the meaning of “guitarist” that it denotes someone who plays guitar.

11. If no articles have been retrieved, the system then tries to bring back so-called Omega relations. Omega relations means that, since the system has not been able to find the specified (or inferred) event involving all of the non-pronominal participants, the system will try to find any relation involving them all.

12. After all the above has been done, the system then finds any arguments that are restricted by qualia, and filters the relations to only those that contain the specified argument with the specified qualia restriction.

13. Next, if the articles found is not empty, the system calculates the related categories:

a. First, the system finds the “most prominent argument”: this is #theme, if this is not a pronoun; then #extemalArgument, if this is not a pronoun; then the first argument it encounters that is not a pronoun; otherwise nil.

b. If there is a “most prominent argument”, the system gets related categories for its type.

c. Related categories are calculated as for type Query without qualia, as described above.

Conclusion

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. A method for answering a query from a user using a computer system, said method comprising:
receiving said query from said user by said computer system;
processing said query using a natural language search;
displaying on a display an answer to said query; and
displaying on said display a plurality of related categories associated with said query.

2. The method of claim 1 wherein the plurality of related categories have associated type information.

3. The method of claim 1 wherein the plurality of related categories are based on semantic content of said query.

4. A method for providing dynamic categories in an information retrieval system, comprising:
receiving a query from a user;
searching for information in response to said query; and
displaying to said user relevant documents categorized into at least one classification based on semantic content of said query.

5. A system for providing related categories in response to a user query, comprising:
a first display window for receiving a query from a user;
an engine coupled to said first display window to produce one or more related categories, in response to said query; and
a portion of said first display window for displaying said one or more related categories.

6. The system of claim 5 wherein said one or more related categories is based on semantic content of said query.

7. A conversational search method using a computer, the method comprising:
receiving a query from a user;
displaying a plurality of selections to said query, wherein at least two selections of said plurality of selections have different senses;
receiving a selection from said user; and
processing said selection to display an answer to said query.

8. The method of claim 7 wherein a sense is related to a type.

9. The method of claim 7 wherein a sense is related to a quale.

10. On a computer system, a method for answering a query from a user, the method comprising:
producing semantic objects based on the semantic content of said query;
accessing an information store to retrieve objects therefrom, based on said semantic objects;
displaying retrieved objects as an answer to said query;
accessing additional information from said information store based on said semantic objects, wherein said additional information is context relevant to said query; and
displaying said additional information.

11. The method of claim 10 wherein said additional information comprises one or more categories of objects that are relevant to the context of said query, wherein said one or more categories are displayed, thereby alerting said user to the presence of relevant additional information.

12. The method of claim 10 wherein said additional information is based on type information associated with said semantic objects.

13. On a computer system, a method for answering a query from a user, the method comprising:
processing said query to produce semantic objects therefrom;
processing said semantic objects to produce dynamic categories based on said semantic objects; and
displaying said dynamic categories.

14. On a computer system, a method for answering a query from a user, the method comprising:
processing said query to produce semantic objects therefrom;
accessing an information store to obtain one or more retrieved objects therefrom based on said semantic objects;
if there is more than one sense among said retrieved objects, then displaying information indicating the occurrence of said more than one sense;
receiving input indicating a selected sense; and
displaying some of said retrieved objects based on said selected sense.

15. The method of claim 14 wherein said retrieved objects each have an associated type and said sense is based on said associated types.

16. The method of claim 14 wherein said semantic objects each have associated qualia and said sense is related to said qualia.
